(19) United States
(12) Patent Application Publication
(10) Pub. No.: US 2014/0305558 A1
(43) Pub. Date: Oct. 16, 2014

(54) TYRE HAVING A TREAD COMPRISING AN IMPREGNATED FELT

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: Vincent Abad, Clermont-Ferrand (FR); Emmanuel Custodero, Clermont-Ferrand (FR)

(73) Assignees: COMPAGNIE GENERALE DES ETABLISSEMENTS MICHELIN, Clermont-Ferrand (FR); Michelin Recherche et Technique S.A., Granges-Paccot (CH)

(21) Appl. No.: 14/365,697

(22) PCT Filed: Dec. 14, 2012
(86) PCT No.: PCT/EP2012/075631

§ 371 Date: Jun. 16, 2014

(30) Foreign Application Priority Data
Dec. 16, 2011 (FR) 1161754

(51) Int. Cl. B60C 1/00

(52) U.S. Cl. CPC B60C 1/0016
USPC 152/209.1

(57) ABSTRACT

A tyre is provided with a tread that includes a felt. The felt is impregnated with a thermoplastic elastomer material. Fibres of the felt are selected from a group that includes: textile fibres, inorganic fibres, and mixtures of textile fibres and inorganic fibres.

The present invention relates to tyres provided with a tread.

An ongoing objective of tyre manufacturers is to improve the wet grip of tyres without damaging the performance of the tyres, such as the behaviour, the wear resistance and the rolling resistance.

In order to obtain a satisfactory running performance, in particular on wet road surfaces, it is known practice to provide a tread of a tyre with a tread pattern formed of tread pattern elements separated from one another by indentations (grooves with a mean width of greater than or equal to 2 mm and/or sipes with a mean width of less than 2 mm), these indentations being obtained, for example, by moulding. The tread pattern elements thus formed comprise a contact face intended to come into contact with the road surface during running and lateral faces also delimiting the indentations; the intersection of each lateral face with the contact face forms an edge corner facilitating contact between the tyre and the road surface, in particular when the road surface is wet. More generally, an edge corner is defined as the geometric limit of contact of a tread pattern element with the ground during running.

With tread pattern elements, a distinction is made between elements which do not go all the way around the tyre (blocks) and elements which do go all the way around the tyre (ribs). Moreover, the tread pattern elements can comprise one or more sipes in order to form additional edge corners, it being or not being possible for each sipe to emerge on at least one lateral face of the tread pattern element. By definition, a sipe is the space delimited by two opposing main faces separated from one another by a width of less than 2 mm.

### BRIEF DESCRIPTION OF THE INVENTION

A subject-matter of the invention is a tyre, characterized in that it comprises a tread comprising a felt impregnated with a thermoplastic elastomer material, the thermoplastic elastomer being a block copolymer comprising at least one elastomer block and at least one thermoplastic block, and in that the fibres of the felt are fibres selected from the group of textile fibres, inorganic fibres and their mixtures.

The Applicant Company has discovered, very surprisingly, that the presence of such an impregnated felt in contact with a wet running ground makes it possible to substantially improve the grip of the tread on this wet ground. Furthermore, the impregnation of the felt with such a block thermoplastic elastomer is particularly easy in the molten state.

According to a first embodiment, the impregnated felt can constitute a portion of the contact faces of the tread pattern elements of the tread of the tyre.

Advantageously, the impregnated felt can constitute the contact face of at least one circumferential rib of the tread.

According to another embodiment, the impregnated felt constitutes the contact face of at least one assembly of tread pattern elements which are positioned axially.

Advantageously, the impregnated felt constitutes the whole of the tread of the tyre.

According to another embodiment, the impregnated felt can constitute a portion of a tread pattern element of the tread.

This tread pattern element can be a circumferential rib or a block.

Advantageously, the impregnated felt constitutes a portion of at least one assembly of blocks of the tread which are positioned axially.

Advantageously, the apparent density of the felt before impregnation is greater than 0.10 and preferably greater than 0.15, in order to obtain a sufficient intrinsic stiffness of the three-dimensional grouping of fibres; this apparent density is also preferably less than 0.40 in the case of textile fibres, in order to make possible easy impregnation of the grouping of fibres by the elastomer material.

The impregnation of the felt by the elastomer material can be carried out by hot calendering or by moulding/injection moulding on the felt or preferably in the molten state.

The use of such a felt impregnated with an elastomer material at the surface of the tread of a tyre has the advantage of making it possible to use elastomer materials of very low rigidity and thus excellent for wet grip, while retaining a high stiffness of the tread pattern elements due to the intrinsic stiffness of the three-dimensional grouping of the fibres of the felt.

The invention relates more particularly to the tyres intended to equip non-motor vehicles, such as bicycles, or motor vehicles of passenger vehicle type, SUVs (“Sport Utility Vehicles”), two-wheel vehicles (in particular motorcycles), aircraft, as well as industrial vehicles chosen from vans, “heavy-duty” vehicles—that is to say, underground trains, buses, heavy road transport vehicles (lorries, tractors, trailers) or off-road vehicles, such as heavy agricultural vehicles or earthmoving equipment —, or other transportation or handling vehicles.

### I. DETAILED DESCRIPTION OF THE INVENTION

In the present description, unless expressly indicated otherwise, all the percentages (%) shown are % by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The term “phr” is understood to mean parts by weight per hundred parts of elastomer.

The expression composition “based on” is understood to mean a composition comprising the mixture and/or the reaction product of the various constituents used, some of these base constituents being capable of reacting or intended to react with one another, at least in part, during the various phases of manufacture of the composition, in particular during the manufacture thereof and the crosslinking or vulcanization thereof

### I-1. Measurements and Tests Used: Measurement of the Coefficient of Friction

The measurements of coefficient of dynamic friction were carried out according to a method identical to that described by L. Busse, A. Le Gal and M. Küppel (Modelling of Dry and Wet Friction of Silica Filled Elastomers on Self-Affine Road Surfaces, Elastomer Friction, 2010, 51, p. 8). The test specimens are produced by moulding, followed by vulcanization, of a square rubber support (50 mm×50 mm) with a thickness of 6 mm covered with felt with a thickness of 2 mm before curing. This thickness varies during the curing and reaches, by way of example, 1.4 mm in the case of the PLB40 felt from Laoureux. After closing the mould, the latter is placed in a press comprising heated platens at 150° C. for 50 minutes at a pressure of 16 bar. The ground used to carry out these measurements is a core withdrawn from a real road surface made of bituminous concrete of BBTM type (Standard NF P 98-137). In order to prevent phenomena of dewetting and the appearance of secondary grip forces between the ground and the material, the ground+test specimen system is immersed in a 5% aqueous solution of a surface-active agent (Sinnozon—CAS number: 25155-30-0). The temperature of the aqueous solution is regulated using a thermostatic bath. The test specimen is subjected to a sliding movement in translation parallel to the plane of the ground. The sliding rate SR is set at 0.03 m/sec. The normal stress applied σₙ is 100 kPa. These conditions are described below by “wet ground conditions”. The tangential stress σₜ, opposed to the movement of the test specimen over the ground, is measured continuously. The ratio of the tangential stress σₜ to the normal stress σₙ gives the coefficient of dynamic friction t. The values shown in the table below are the values of coefficient of dynamic friction obtained under continuous operating conditions after stabilization of the value of the tangential stress σₜ.

### I-2. Felt

The tyre according to the invention has the essential characteristic of comprising a tread with a felt composed of fibres selected from the group of textile fibres, inorganic fibres and their mixtures.

The presence of this felt makes it possible to substantially improve the wet grip of the tyre.

In that which follows, “felt” or “nonwoven” of fibres is understood to mean any manufactured product composed of a veil, of a web or of a mat of fibres, whether they are distributed directionally or by chance, the fibres of which are entangled or intermixed in three dimensions.

The methods of manufacture of such felts are well known, in particular by needling or padding.

The fibres of the felt can be selected from textile fibres of natural origin, for example, from the group of silk, cotton, bamboo, cellulose and wool fibres and their mixtures.

Examples of wool felts are the “PLB” and “MLB” felts from Laoureux. These felts are sold with an apparent density variable between 0.20 and 0.44.

The fibres of the felt can also be selected from the group of synthetic textile fibres, for example polyester, polyamide, carbon, aramid, polyethylene, polypropylene, polyacrylonitrile, polyimide, polysulphone, polyethersulphone, polyurethane and polyvinyl alcohol fibres and their mixtures.

The polyester fibres of the felt can advantageously be selected from the group of polyethylene terephthalate (PET—Dacron Invista Inc.) fibres, polybutylene terephthalate (PBT) fibres, polyethylene naphthalate (PEN) fibres and their mixtures.

Mention may be made, as example of felts composed of aramid fibres, of the felts produced with Nomex® (meta-aramid: poly(m-phenylene isophthalamide), fibres, having the abbreviation MPD-I) fibres from Du Pont de Nemours.

The fibres of the felt can also be selected from the group of inorganic fibres, for example glass fibres and basalt fibres.

The felts can be composed without distinction of several types of fibres from one and the same group or from different groups as described above.

I-3. Impregnated felt

According to an essential characteristic of the invention, the felts used in cavities of the tread are impregnated with a thermoplastic elastomer material, the thermoplastic elastomer being a block copolymer comprising at least one elastomer block and at least one thermoplastic block.

### I-3-A Thermoplastic Elastomer

Thermoplastic elastomers (abbreviated to “TPEs”) have a structure intermediate between thermoplastic polymers and elastomers. These are block copolymers composed of rigid thermoplastic blocks connected via flexible elastomer blocks.

The thermoplastic elastomer used for the implementation of the invention is a block copolymer, the chemical nature of the thermoplastic blocks and elastomer blocks of which can vary.

### I-3-A-1 Structure of the TPE

The number-average molecular weight (denoted Mn) of the TPE is preferably between 30 000 and 500 000 g/mol, more preferably between 40 000 and 400 000 g/mol. Below the minima indicated, there is a risk of the cohesion between the elastomer chains of the TPE being affected, in particular due to its possible dilution (in the presence of an extending oil); furthermore, there is a risk of an increase in the working temperature affecting the mechanical properties, in particular the properties at break, with the consequence of a reduced “hot” performance. Furthermore, an excessively high weight Mn can be damaging to the use. Thus, it has been found that a value within a range from 50 000 to 300 000 g/mol was particularly well suited, in particular to use of the TPE in a tyre tread composition.

The number-average molecular weight (Mn) of the TPE elastomer is determined, in a known manner, by steric exclusion chromatography (SEC). For example, in the case of styrene thermoplastic elastomers, the sample is dissolved beforehand in tetrahydrofuran at a concentration of approximately 1 g/1 and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards. The conditions can be adjusted by a person skilled in the art.

The value of the polydispersity index PI (reminder: PI=Mw/Mn, with Mw the weight-average molecular weight and Mn the number-average molecular weight) of the TPE is preferably less than 3, more preferably less than 2 and more preferably still less than 1.5.

In the present patent application, when reference is made to the glass transition temperature of the TPE, it concerns the Tg relative to the elastomer block. The TPE preferably exhibits a glass transition temperature (“Tg”) which is preferably less than or equal to 25° C., more preferably less than or equal to 10° C. A Tg value greater than these minima can reduce the performance of the tread when used at very low temperature; for such a use, the Tg of the TPE is more preferably still less than or equal to −10° C. Preferably again, the Tg of the TPE is greater than −100° C.

In a known way, TPEs exhibit two glass transition temperature peaks (Tg, measured according to ASTM D3418), the lowest temperature being relative to the elastomer part of the TPE and the highest temperature being relative to the thermoplastic part of the TPE. Thus, the flexible blocks of the TPEs are defined by a Tg which is lower than ambient temperature (25° C.), while the rigid blocks have a greater Tg.

In order to be both elastomeric and thermoplastic in nature, the TPE has to be provided with blocks which are sufficiently incompatible (that is to say, different as a result of their respective weights, their respective polarities or their respective Tg values) to retain their own properties of elastomer block or thermoplastic block.

The TPEs can be copolymers with a small number of blocks (less than 5, typically 2 or 3), in which case these blocks preferably have high weights of greater than 15 000 g/mol. These TPEs can, for example, be diblock copolymers, comprising a thermoplastic block and an elastomer block. They are often also triblock elastomers with two rigid segments connected by a flexible segment. The rigid and flexible segments can be positioned linearly, or in a star or branched configuration. Typically, each of these segments or blocks often comprises a minimum of more than 5, generally of more than 10, base units (for example, styrene units and butadiene units for a styrene/butadiene/styrene block copolymer).

The TPEs can also comprise a large number of smaller blocks (more than 30, typically from 50 to 500), in which case these blocks preferably have relatively low weights, for example from 500 to 5000 g/mol; these TPEs will subsequently be referred to as multiblock TPEs and are an elastomer block/thermoplastic block series.

According to a first alternative form, the TPE is provided in a linear form. For example, the TPE is a diblock copolymer: thermoplastic block/elastomer block. The TPE can also be a triblock copolymer: thermoplastic block/elastomer block/thermoplastic block, that is to say a central elastomer block and two terminal thermoplastic blocks, at each of the two ends of the elastomer block. Equally, the multiblock TPE can be a linear series of elastomer blocks/thermoplastic blocks.

According to another alternative form of the invention, the TPE of use for the requirements of the invention is provided in a star-branched form comprising at least three branches. For example, the TPE can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to another alternative form of the invention, the TPE is provided in a branched or dendrimer form. The TPE can then be composed of a branched or dendrimer elastomer block and of a thermoplastic block located at the end of the branches of the dendrimer elastomer block.

### I-3-A-2 Nature of the Elastomer Blocks

The elastomer blocks of the TPE for the requirements of the invention can be any elastomer known to a person skilled in the art. They preferably have a Tg of less than 25° C., preferably of less than 10° C., more preferably of less than 0° C. and very preferably of less than −10° C. Preferably again, the Tg of the elastomer block of the TPE is greater than −100° C.

For the elastomer blocks comprising a carbon-based chain, if the elastomer part of the TPE does not comprise an ethylenic unsaturation, it will be referred to as a saturated elastomer block. If the elastomer block of the TPE comprises ethylenic unsaturations (that is to say, carbon-carbon double bonds), it will then be referred to as an unsaturated or diene elastomer block.

A saturated elastomer block is composed of a polymer sequence obtained by the polymerization of at least one (that is to say, one or more) ethylenic monomer, that is to say, a monomer comprising a carbon-carbon double bond. Mention may be made, among the blocks resulting from these ethylenic monomers, of polyalkylene blocks, such as ethylene/propylene or ethylene/butylene random copolymers. These saturated elastomer blocks can also be obtained by hydrogenation of unsaturated elastomer blocks. They can also be aliphatic blocks resulting from the families of the polyethers, polyesters or polycarbonates.

In the case of saturated elastomer blocks, this elastomer block of the TPE is preferably predominantly composed of ethylenic units. Predominantly is understood to mean the highest content by weight of ethylenic monomer, with respect to the total weight of the elastomer block, and preferably a content by weight of more than 50%, more preferably of more than 75% and more preferably still of more than 85%.

Conjugated C₄-C₁₄ dienes can be copolymerized with the ethylenic monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture comprising isoprene.

In the case of unsaturated elastomer blocks, this elastomer block of the TPE is preferably predominantly composed of a diene elastomer part. Predominantly is understood to mean the highest content by weight of diene monomer, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type, which is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the monomers polymerized in order to form the elastomer part of the TPE can be randomly copolymerized with at least one other monomer, so as to form an elastomer block. According to this alternative form, the molar fraction of polymerized monomer, other than an ethylenic monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

By way of illustration, this other monomer capable of copolymerizing with the first monomer can be chosen from ethylenic monomers as defined above (for example ethylene), diene monomers, more particularly the conjugated diene monomers having from 4 to 14 carbon atoms as defined above (for example butadiene), monomers of vinylaromatic type having from 8 to 20 carbon atoms as defined below, or also a monomer such as vinyl acetate may be involved.

When the comonomer is of vinylaromatic type, it advantageously represents a fraction of units, with regard to the total number of units of the thermoplastic block, from 0% to 50%, preferably ranging from 0% to 45% and more preferably still ranging from 0% to 40%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

According to a preferred embodiment of the invention, the elastomer blocks of the TPE exhibit, in total, a number-average molecular weight (Mn) ranging from 25 000 g/mol to 350 000 g/mol, preferably from 35 000 g/mol to 250 000 g/mol, so as to confer, on the TPE, good elastomeric properties and a mechanical strength which is sufficient and compatible with the use as tyre tread.

The elastomer block can also be a block comprising several types of ethylenic, diene or styrene monomers as defined above.

The elastomer block can also be composed of several elastomer blocks as defined above.

### I-3-A-3 Nature of the Thermoplastic Blocks

Use will be made, for the definition of the thermoplastic blocks, of the characteristic of glass transition temperature (Tg) of the rigid thermoplastic block. This characteristic is well known to a person skilled in the art. It makes it possible in particular to choose the industrial processing (transformation) temperature. In the case of an amorphous polymer (or polymer block), the processing temperature is chosen to be substantially greater than the Tg. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “Tg (or M.p., if appropriate)”, it will be necessary to consider that this is the temperature used to choose the processing temperature.

For the requirements of the invention, the TPE elastomers comprise one or more thermoplastic block(s) preferably having a Tg (or M.p., if appropriate) of greater than or equal to 80° C. and formed from polymerized monomers. Preferably, this thermoplastic block has a Tg (or M.p., if appropriate) within a range varying from 80° C. to 250° C. Preferably, the Tg (or M.p., if appropriate) of this thermoplastic block is preferably from 80° C. to 200° C., more preferably from 80° C. to 180° C.

The proportion of the thermoplastic blocks, with respect to the TPE as defined for the implementation of the invention, is determined, on the one hand, by the thermoplasticity properties which the said copolymer has to exhibit. The thermoplastic blocks having a Tg (or M.p., if appropriate) of greater than or equal to 80° C. are preferably present in proportions sufficient to retain the thermoplastic nature of the elastomer according to the invention. The minimum content of thermoplastic blocks having a Tg (or M.p., if appropriate) of greater than or equal to 80° C. in the TPE can vary as a function of the conditions of use of the copolymer. On the other hand, the ability of the TPE to deform during the preparation of the tyre can also contribute to determining the proportion of the thermoplastic blocks having a Tg (or M.p., if appropriate) of greater than or equal to 80° C.

The thermoplastic blocks having a Tg (or M.p., if appropriate) of greater than or equal to 80° C. can be formed from polymerized monomers of various natures; in particular, they can constitute the following blocks or their mixtures:

polyolefins (polyethylene, polypropylene);

polyurethanes;

polyamides;

polyesters;

polyacetals;

polyethers (polyethylene oxide, polyphenylene ether);

polyphenylene sulphides;

polyfluorinated compounds (FEP, PFA, ETFE);

polystyrenes (described in detail below);

polycarbonates;

polysulphones;

polymethyl methacrylate;

polyetherimide;

thermoplastic copolymers, such as the acrylonitrile/butadiene/styrene (ABS) copolymer.

The thermoplastic blocks having a Tg (or M.p., if appropriate) of greater than or equal to 80° C. can also be obtained from monomers chosen from the following compounds and their mixtures:

acenaphthylene: a person skilled in the art may refer, for example, to the paper by Z. Fodor and J. P. Kennedy, Polymer Bulletin, 1992, 29(6), 697-705;

indene and its derivatives, such as, for example, 2-methylindene, 3-methylindene, 4-methylindene, dimethylindene, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;

isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

The polystyrenes are obtained from styrene monomers. Styrene monomer should be understood as meaning, in the present description, any monomer comprising styrene, unsubstituted and substituted; mention may be made, among substituted styrenes, for example, of methylstyrenes (for example, o-methylstyrene, m-methylstyrene or p-methylstyrene, a-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

According to a preferred embodiment of the invention, the content by weight of styrene in the TPE elastomer is between 5% and 50%. Below the minimum indicated, there is a risk of the thermoplastic nature of the elastomer being substantially reduced while, above the recommended maximum, the elasticity of the tread can be affected. For these reasons, the styrene content is more preferably between 10% and 40%.

According to an alternative form of the invention, the polymerized monomer as defined above can be copolymerized with at least one other monomer, so as to form a thermoplastic block having a Tg (or M.p., if appropriate) as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, such as defined in the part relating to the elastomer block.

According to the invention, the thermoplastic blocks of the TPE exhibit, in total, a number-average molecular weight (“Mn”) ranging from 5 000 g/mol to 150 000 g/mol, so as to confer, on the TPE, good elastomeric properties and a mechanical strength which is sufficient and compatible with the use as tyre tread.

The thermoplastic block can also be composed of several thermoplastic blocks as defined above.

### I-3-A-4 TPE Examples

For example, the TPE is a copolymer, the elastomer part of which is saturated and which comprises styrene blocks and alkylene blocks. The alkylene blocks are preferably of ethylene, propylene or butylene. More preferably, this TPE elastomer is selected from the following group consisting of diblock or triblock copolymers which are linear or star-branched: styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEBS), styrene/ethylene/ethylene/propylene/styrene (SEEPS), styrene/isobutylene (SIB), styrene/isobutylene/styrene (SIBS) and the mixtures of these copolymers.

According to another example, the TPE is a copolymer, the elastomer part of which is unsaturated and which comprises styrene blocks and diene blocks, these diene blocks being in particular isoprene or butadiene blocks. More preferably, this TPE elastomer is selected from the following group consisting of diblock or triblock copolymers which are linear or star-branched: styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS) and the mixtures of these copolymers.

For example again, the TPE is a linear or star-branched copolymer, the elastomer part of which comprises a saturated part and an unsaturated part, such as, for example, styrene/butadiene/butylene (SBB), styrene/butadiene/butylene/styrene (SBBS) or a mixture of these copolymers.

Mention may be made, among multiblock TPEs, of the copolymers comprising random copolymer blocks of ethylene and propylene/polypropylene, polybutadiene/polyurethane (TPU), polyether/polyester (COPE) or polyether/polyamide (PEBA).

It is also possible for the TPEs given as example above to be mixed with one another within the tread according to the invention.

Mention may be made, as examples of commercially available TPE elastomers, of the elastomers of SEPS, SEEPS or SEBS type sold by Kraton under the Kraton G name (e.g., G1650, G1651, G1654 and G1730 products) or Kuraray under the Septon name (e.g., Septon 2007, Septon 4033 or Septon 8004), or the elastomers of SIS type sold by Kuraray under the name Hybrar 5125 or sold by Kraton under the name D1161, or also the elastomers of linear SBS type sold by Polimeri Europa under the name Europrene SOL T 166 or of star-branched SBS type sold by Kraton under the name D1184. Mention may also be made of the elastomers sold by Dexco Polymers under the Vector name (e.g., Vector 4114 or Vector 8508). Mention may be made, among multiblock TPEs, of the Vistamaxx TPE sold by Exxon; the COPE TPE sold by DSM under the Arnitel name or by DuPont under the Hytrel name or by Ticona under the Riteflex name; the PEBA TPE sold by Arkema under the PEBAX name; or the TPU TPE sold by Sartomer under the name TPU 7840 or by BASF under the Elastogran name.

### I-3-A-5 TPE Amount

If optional other elastomers (non-thermoplastic) are used in the thermoplastic elastomer composition, the TPE elastomer or elastomers constitute the predominant fraction by weight. Thus, the amount of TPE elastomer is within a range which varies from 65 to 100 phr, preferably from 70 to 100 phr. It is clearly understood that the sum of the amounts of the TPE and diene elastomers is always 100 phr.

The TPE elastomer or elastomers are preferably the only elastomer or elastomers of the tread.

### I-3-B Other Components of the Composition

The composition can also comprise various fillers or additives, such as non-reinforcing or nanometric reinforcing fillers.

The composition of the elastomer material can also comprise all or a portion of the usual additives generally used in elastomer compositions intended for the manufacture of tyres, such as, for example, pigments, protective agents, such as antiozone waxes, chemical antiozonants or antioxidants, antifatigue agents, reinforcing resins, methylene acceptors (for example phenolic novolak resin) or methylene donors (for example HMT or H3M), such as described, for example, in Application WO 02/10269, a crosslinking system based either on sulphur or on sulphur donors and/or on peroxide and/or on bismaleimides, vulcanization accelerators or vulcanization activators.

The formulation of the elastomer material can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

The elastomer material can also comprise, as preferred non-aromatic or very weakly aromatic plasticizing agent, at least one compound selected from the group consisting of naphthenic oils, paraffinic oils, MES oils, TDAE oils, ester plasticizers (for example glycerol trioleates), hydrocarbon resins exhibiting a high Tg, preferably of greater than 30° C., such as described, for example, in Applications WO 2005/087859, WO 2006/061064 and WO 2007/017060, and the mixtures of such compounds. The overall content of such a preferred plasticizing agent is preferably between 10 and 100 phr, more preferably between 20 and 80 phr, in particular within a range from 10 to 50 phr.

Mention will in particular be made, among the above plasticizing hydrocarbon resins (it will be remembered that the name “resin” is reserved by definition for a solid compound), of resins formed of homo- or copolymers of α-pinene, β-pinene, dipentene or polylimonene, C₅ fraction, for example formed of C₅ fraction/styrene copolymer or formed of C₅ fraction/C₉ fraction copolymer, which can be used alone or in combination with plasticizing oils, such as, for example, MES or TDAE oils.

### I-3-C Preparation

The TPE elastomers can be processed in the conventional way for TPEs, by extrusion or moulding, for example using a starting material available in the form of beads or granules.

The elastomer material based on a thermoplastic elastomer according to the invention is prepared in a conventional way, for example by incorporation of the various components in a twin-screw extruder, so as to carry out the melting of the matrix and the incorporation of all the ingredients, followed by use of a die which makes it possible to produce the profiled element. The impregnation of the felt by the elastomer material is subsequently carried out as indicated above by hot calendering or injection under pressure. This impregnation is particularly easy to carry out due to the thermoplastic nature of this elastomer material.

If the elastomer block of the TPE is a saturated elastomer block, it may be necessary to include, between the impregnated felt and the wall of the cavity of the tread, an adhesion film or layer which will comprise a TPE comprising an unsaturated elastomer block in order to promote the adhesion between said impregnated felt and the adjacent layer of the tread within the finished tyre.

### DESCRIPTION OF THE FIGURES

The appended figures illustrate embodiments of a tyre tread incorporating an impregnated felt:

FIG. 1 exhibits a first embodiment of a tread of a tyre incorporating an impregnated felt;

FIG. 2 exhibits a second embodiment of a tread of a tyre incorporating an impregnated felt;

FIG. 3 exhibits a third embodiment of a tread of a tyre incorporating an impregnated felt;

FIG. 4 exhibits a fourth embodiment of a tread of a tyre incorporating an impregnated felt;

FIG. 5 exhibits, in top view and highly diagrammatically, a portion of tread, several blocks of which incorporate an impregnated felt.

### EXAMPLES OF THE IMPLEMENTATION OF THE INVENTION

In the figures, axes X, Y and Z have been represented which are orthogonal to one another and which correspond to the normal circumferential (X), axial (Y) and radial (Z) orientations of a tyre.

The term “substantially circumferential orientation” is understood to mean an average orientation which does not deviate by more than 5° from the circumferential direction X.

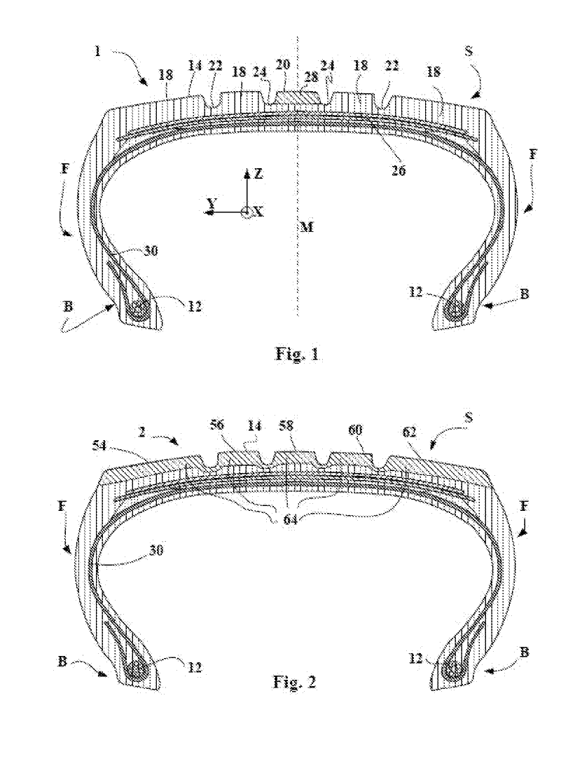

FIG. 1 depicts a tyre according to one embodiment of the invention denoted by the general reference 1. Conventionally, the tyre 10 comprises a crown S extended by two sidewalls F and two beads B.

Two bead wires 12 are embedded in the beads B. The two bead wires 12 are arranged symmetrically with respect to a median radial plane M of the tyre.

Each bead wire 12 exhibits symmetry of revolution about a reference axis. This reference axis, substantially parallel to the direction Y, is substantially coincident with an axis of revolution of the tyre.

The tyre 1 also comprises a carcass reinforcement 30, the ends of which are wound around the bead wires 12. The carcass reinforcement in the example represented comprises one or more textile reinforcing plies oriented substantially radially.

The crown S comprises a tread 14 provided with tread patterns 18 and 20 separated by indentations or grooves 22 and 24, and also a normal crown reinforcement 26. The two grooves 24 surround the central tread pattern 20, which is a circumferential rib.

The radially outer part and the contact face of the circumferential rib 20 are composed of an impregnated felt 28 which extends circumferentially over the entire periphery of the tread of the tyre.

FIG. 2 exhibits an axial cross-section of a tyre 2 similar to that of FIG. 1 according to another embodiment of the invention. In this axial cross-section, all of the blocks or tread pattern elements 54, 56, 58, 60 and 62 of the tread 14 of the tyre are composed of an impregnated felt 64. This impregnated felt extends axially and circumferentially over the whole of the crown of the tyre. A rubber underlayer (not represented) can be positioned between the impregnated felt and the crown reinforcement.

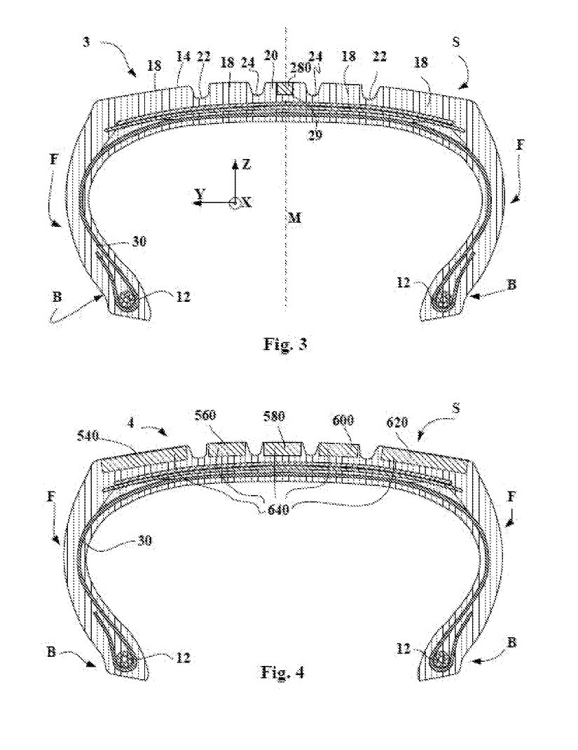

FIG. 3 exhibits an axial cross-section of a tyre 3 similar to that of FIG. 1 according to another embodiment of the invention. In this embodiment, a cavity 29 is filled with an impregnated felt 280. The cavity 29 extends circumferentially in a continuous or non-continuous fashion.

FIG. 4 exhibits an axial cross-section of a tyre 4 similar to that of FIG. 2 according to another embodiment of the invention. The tread of this tyre 4 comprises a plurality of cavities 540, 560, 580, 600 and 620 positioned in blocks placed axially with respect to one another. Each cavity is filled with an impregnated felt 640. The cavities extend circumferentially over a distance of between 5 and 30 mm. The number of cavities in the circumferential direction is of the order of 10 to 20. This number is such that, under normal running conditions, at least one axial assembly of blocks comprising cavities with impregnated felts is continuously in the contact area.

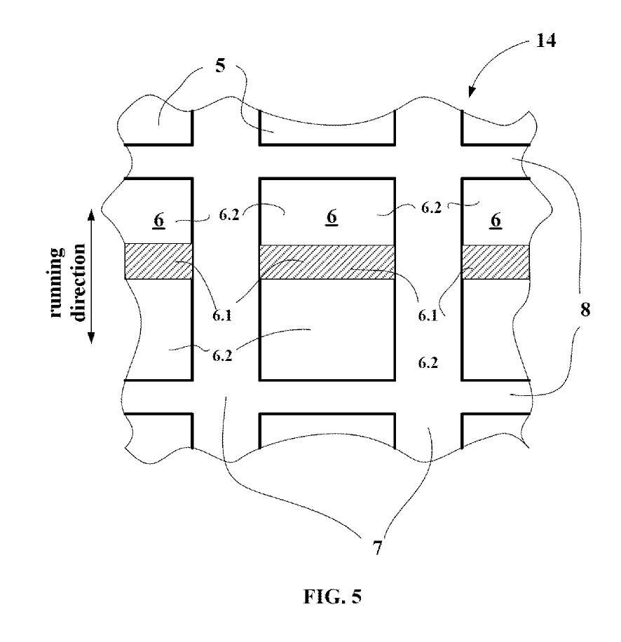

FIG. 5 is a partial and highly diagrammatic top view of a tread according to an embodiment similar to that of FIG. 4. The tread 14 comprises a running surface 5 and an assembly of blocks 6 which are delimited by circumferential grooves 7 and axial grooves 8. The blocks 6 comprise an impregnated felt 6.2 positioned between two rubber parts 6.1. In this embodiment and contrary to the embodiment illustrated in FIG. 4, the impregnated felts 6.2 constitute a portion of the side faces of the blocks 6.

The blanks of these tyres are produced in the normal way by successive stacking of the different elements of the tyre. After their impregnation by the chosen elastomer material, the impregnated strips of felt can be positioned circumferentially or axially or also in cavities. The blank is then placed in the vulcanization mould and the moulding of the tread is carried out conventionally during the closing of the mould, followed by the vulcanization of the blank.

### I-4. Trials

The coefficient of dynamic friction of test specimens composed, on the one hand, of a tyre tread standard mixture and, on the other hand, of wool felt impregnated with a thermoplastic elastomer, was determined under the conditions described above. The results presented below are presented in base 100: an arbitrary value of 100 is given for the coefficient of friction of the control, a result greater than 100 indicating a better grip performance.

The composition of the tread control mixture (A-1) is presented in Table 1 below, along with the thermoplastic elastomer composition impregnating the wool felt MLB25 from Laoureux (A-2).

TABLE 1

| | A-1 | A-2 |
|---|---|---|
| Composition | (phr) | (phr) |
| SBR (1) | 40 | 0 |
| SBR (2) | 60 | 0 |
| TPE elastomer (3) | 0 | 100 |
| Silica (4) | 90 | 0 |
| Coupling agent (5) | 7.5 | 0 |
| Carbon black (6) | 4 | 0 |
| Liquid plasticizer 1 (7) | 20 | 0 |
| Liquid plasticizer 2 (8) | 0 | 20 |
| Resin (9) | 20 | 0 |
| Antiozone wax | 1.5 | 0 |
| Antioxidant (10) | 2 | 0 |
| DPG (11) | 1.5 | 0 |
| ZnO (12) | 2.75 | 0 |
| Stearic acid (13) | 2 | 0 |
| CBS (14) | 2.1 | 0 |
| Sulphur | 1.4 | 0 |

(1) Solution SBR (contents expressed as dry SBR: 41% of styrene, 24% of 1,2-polybutadiene units and 51% of trans-1,4-polybutadiene units (Tg = −25° C.));
(2) Solution SBR (contents expressed as dry SBR: 29% of styrene, 5% of 1,2-polybutadiene units and 80% of trans-1,4-polybutadiene units (Tg = −56° C.));
(3) SIS thermoplastic elastomer, Hybrar 5125, from Kuraray;
(4) Silica (Zeosil 1165MP from Rhodia);
(5) TESTP coupling agent (Si69 from Degussa);
(6) Carbon black N234;
(7) TDAE oil, Vivatec 500, from Hansen & Rosenthal;
(8) Paraffinic oil, Extensoil 51 24T from Repsol or Tudalen 1968 from Klaus Dahleke;
(9) C₅/C₉ Resin, Cray Valley Wingtack from STS;
(10) N-(1,3-Dimethylbutyl)-N-phenyl-para-phenylenediamine (Santoflex 6-PPD from Flexsys);
(11) DPG = Diphenylguanidine (Perkacit DPG from Flexsys);
(12) Zinc oxide (industrial grade-Umicore);
(13) Stearin (Pristerene from Uniqema);
(14) N-Cyclohexyl-2-benzothiazolesulphenamide (Santocure CBS from Flexsys).

The measurements of coefficient of dynamic friction were carried out under wet ground conditions, at a sliding rate of 0.03 m/s, under a normal pressure of 1 bar and at three temperatures (3, 20 and 40° C.). The results are presented in Table 2.

TABLE 2

| | | | |
|---|---|---|---|
| Temperature (° C.) | 3 | 20 | 40 |
| Control | 100 | 100 | 100 |
| Impregnated felt MLB25 | 114 | 134 | 140 |

The results presented in Table 2 demonstrate that the test specimens composed of wool felt impregnated with a thermoplastic elastomer make possible a significant improvement in the wet grip. The improvement is particularly sensitive to moderate and high temperatures.

1-22. (canceled)

23: A tyre comprising a tread,
wherein the tread includes a felt impregnated with an elastomer material based on at least one thermoplastic elastomer,
wherein each thermoplastic elastomer is a block copolymer that includes at least one elastomer block and at least one thermoplastic block, and
wherein fibres of the impregnated felt are selected from a group that includes: textile fibres, inorganic fibres, and mixtures of textile fibres and inorganic fibres.

24. The tyre according to claim 23,
wherein the tread includes tread pattern elements, each tread pattern element including a contact face, and
wherein the impregnated felt constitutes a portion of the contact faces of the tread pattern elements.

25. The tyre according to claim 24,
wherein the tread includes a circumferential rib, and
wherein the impregnated felt constitutes a contact face of the circumferential rib.

26. The tyre according to claim 24,
wherein the tread includes a group of tread pattern elements positioned axially, each tread pattern element including a contact face, and
wherein the impregnated felt constitutes the contact faces of the tread pattern elements of the group.

27. The tyre according to claim 24, wherein the impregnated felt constitutes an entirety of the tread.

28. The tyre according to claim 23,
wherein the tread includes a tread pattern element, and
wherein the impregnated felt constitutes a portion of the tread pattern element.

29. The tyre according to claim 28,
wherein the tread includes a circumferential rib, and
wherein the impregnated felt constitutes a portion of the circumferential rib.

30. The tyre according to claim 28,
wherein the tread includes a block, and
wherein the impregnated felt constitutes a portion of the block.

31. The tyre according to claim 30,
wherein the tread includes a group a blocks positioned axially, and
wherein the impregnated felt constitutes a portion of the group of blocks.

32. The tyre according to claim 23, wherein the fibres of the impregnated felt are selected from a group of fibres that includes: silk fibres, cotton fibres, cellulose fibres, bamboo fibres, wool fibres, and mixtures thereof.

33. The tyre according to claim 32, wherein the fibres of the impregnated felt are wool fibres.

34. The tyre according to claim 23, wherein the fibres of the impregnated felt are selected from a group of fibres that includes: polyamide fibres, aramid fibres, carbon fibres, polyethylene fibres, polypropylene fibres, polyacrylonitrile fibres, polyimide fibres, polysulphone fibres, polyethersulphone fibres, polyurethane fibres, polyvinyl alcohol fibres, polyester fibres, polyvinyl chloride fibres, and mixtures thereof.

35. The tyre according to claim 34, wherein the fibres of the impregnated felt are polyester fibres selected from a group of fibres that includes: polyethylene terephthalate (PET) fibres, polybutylene terephthalate (PBT) fibres, polyethylene naphthalate (PEN) fibres, and mixtures thereof.

36. The tyre according to claim 23, wherein the fibres of the impregnated felt are inorganic fibres selected from a group that includes: glass fibres and basalt fibres.

37. The tyre according to claim 23, wherein the impregnated felt, prior to impregnation, has an apparent density of greater than 0.10, with greater than 0.15 being preferable for the apparent density.

38. The tyre according to claim 23, wherein the at least one elastomer block of the block copolymer is or are chosen from elastomers having a glass transition temperature of less than 25° C.

39. The tyre according to claim 38, wherein the at least one elastomer block of the block copolymer is or are selected from a group of elastomers consisting of: ethylene elastomers, diene elastomers, and mixtures thereof.

40. The tyre according to claim 39, wherein the at least one elastomer block of the block copolymer is or are at least one diene elastomer resulting from isoprene, or butadiene, or an isoprene mixture, or a butadiene mixture, or a mixture including isoprene and butadiene.

41. The tyre according to claim 38, wherein the at least one thermoplastic block of the block copolymer is or are chosen from polymers having a glass transition temperature greater than 80° C. and, in a case in which the at least one thermoplastic block includes a semicrystalline thermoplastic block, a melting point of greater than 80° C.

42. The tyre according to claim 38, wherein the at least one thermoplastic block of the block copolymer is or are selected from a group of copolymers consisting of: polyolefins, polyurethanes, polyamides, polyesters, polyacetals, polyethers, polyphenylene sulphides, polyfluorinated compounds, polystyrenes, polycarbonates, polysulphones, polymethyl methacrylate copolymers, polyetherimide copolymers, thermoplastic copolymers, and mixtures thereof.

43. The tyre according to claim 38, wherein the at least one thermoplastic block of the block copolymer is or are chosen from polystyrenes.

44. The tyre according to claim 38, wherein the at least one thermoplastic elastomer is or are selected from a group of copolymers consisting of: styrene/butadiene (SB) copolymers, styrene/isoprene (SI) copolymers, styrene/butadiene/isoprene (SBI) copolymers, styrene/butadiene/styrene (SBS) copolymers, styrene/isoprene/styrene (SIS) copolymers, styrene/butadiene/isoprene/styrene (SBIS) copolymers, linear or star-branched styrene/isobutylene (SIB) copolymers, styrene/isobutylene/styrene (SIBS) thermoplastic elastomer copolymers, and mixtures thereof.
